(19) United States
(12) Patent Application Publication
(10) Pub. No.: US 2010/0150027 A1
(43) Pub. Date: Jun. 17, 2010

(54) SYSTEMS AND METHODS OF PLANNING AND DEPLOYING AN AD HOC MOBILE WIRELESS NETWORK

(76) Inventors: Peter Atwal, Longwood, FL (US); Ludger Schlicht, Boca Raton, FL (US); Scott Y. Seidel, Fairfax, VA (US); Victor M. T. Pataca, Stuart, FL (US)

Correspondence Address: STRATEGIC PATENTS P.C.., C/O PORTFOLIOIP, P.O. BOX 52050, MINNEAPOLIS, MN, 55402, US

(21) Appl. No.: 12/634,440

(22) Filed: Dec. 9, 2009

Related U.S. Application Data
(63) Continuation-in-part of application No. 12/418,363, filed on Apr. 3, 2009.
(60) Provisional application No. 61/121,169, filed on Dec. 9, 2008.
(60) Provisional application No. 61/042,431, filed on Apr. 4, 2008.
(60) Provisional application No. 61/042,442, filed on Apr. 4, 2008.
(60) Provisional application No. 61/074,930, filed on Jun. 23, 2008.
(60) Provisional application No. 61/082,618, filed on Jul. 22, 2008.
(60) Provisional application No. 61/082,642, filed on Jul. 22, 2008.
(60) Provisional application No. 61/086,242, filed on Aug. 5, 2008.
(60) Provisional application No. 61/084,738, filed on Jul. 30, 2008.
(60) Provisional application No. 61/084,773, filed on Jul. 30, 2008.
(60) Provisional application No. 61/094,394, filed on Sep. 4, 2008.
(60) Provisional application No. 61/094,546, filed on Sep. 5, 2008.
(60) Provisional application No. 61/094,584, filed on Sep. 5, 2008.
(60) Provisional application No. 61/094,591, filed on Sep. 5, 2008.
(60) Provisional application No. 61/094,594, filed on Sep. 5, 2008.
(60) Provisional application No. 61/094,611, filed on Sep. 5, 2008.
(60) Provisional application No. 61/095,298, filed on Sep. 8, 2008.
(60) Provisional application No. 61/095,310, filed on Sep. 9, 2008.
(60) Provisional application No. 61/103,106, filed on Oct. 6, 2008.
(60) Provisional application No. 61/111,384, filed on Nov. 5, 2008.
(60) Provisional application No. 61/112,131, filed on Nov. 6, 2008.
(60) Provisional application No. 61/118,232, filed on Nov. 26, 2008.

(30) Foreign Application Priority Data
Jul. 22, 2009 (US) PCT/US09/51467
Sep. 4, 2009 (US) PCT/US09/56130
Sep. 4, 2009 (US) PCT/US09/56134

(51) Int. Cl. H04W 16/18

(52) U.S. Cl. 370/254

(57) ABSTRACT

Wireless ad hoc networking enhancements are disclosed to enable deployment of networks with greater coverage. Analysis is provided which examines the environment and structures in which the wireless network operates and identifies location to place additional access points. Spanning network coverage may be computed along with the identification of coverage holes and hot spots for areas of busy communications.

### RELATED APPLICATIONS

This application claims the benefit of U.S. Provisional Patent Application No. 61/121,169 filed on Dec. 9, 2008.

This application claims priority to the following PCT applications: PCT/US09/56134 filed on Sep. 4, 2009; PCT/US09/51467 filed on Jul. 22, 2009 and PCT/US09/56130 filed on Sep. 4, 2009.

This application is a continuation-in-part of U.S. application Ser. No. 12/418,363 filed on Apr. 3, 2009 which claims the benefit of the following applications: U.S. App. No. 61/042,431 filed on Apr. 4, 2008; U.S. App. No. 61/042,442 filed on Apr. 4, 2008, U.S. App. No. 61/074,930 filed on Jun. 23, 2008; U.S. App. No. 61/082,618 filed on Jul. 22, 2008; U.S. App. No. 61/082,642 filed on Jul. 22, 2008; U.S. App. No. 61/084,738 filed on Jul. 30, 2008; U.S. App. No. 61/084,773 filed on Jul. 30, 2008; U.S. App. No. 61/086,242 filed on Aug. 5, 2008; U.S. App. No. 61/094,394 filed Sep. 4, 2008; U.S. App. No. 61/094,546 filed on Sep. 5, 2008; U.S. App. No. 61/094,584 filed on Sep. 5, 2008; U.S. App. No. 61/094,591 filed on Sep. 5, 2008; U.S. App. No. 61/094,594 filed on Sep. 5, 2008; U.S. App. No. 61/094,611 filed on Sep. 5, 2008; U.S. App. No. 61/095,298 filed on Sep. 8, 2008; U.S. App. No. 61/095,310 filed on Sep. 9, 2008; U.S. App. No. 61/103,106 filed on Oct. 6, 2008; U.S. App. No. 61/111,384 filed on Nov. 5, 2008; U.S. App. No. 61/112,131 filed on Nov. 6, 2008; and U.S. App. No. 61/118,232 filed on Nov. 26, 2008.

Each of the foregoing applications is incorporated herein by reference in its entirety.

### FIELD OF INVENTION

This application relates generally to networking and more particularly to planning and deployment of an ad hoc mobile wireless network.

### BACKGROUND

Wireless networks include the placement of towers, antennas, and access points throughout a region to enable connection of subscriber devices to the wireless networks. Determining the placement of the towers, antennas, and access points can be rather problematical given the surrounding buildings, foliage, and interference to the wireless signals. Historically, solutions have involved placement of antennas in central, high elevation locations and boosting the power sufficiently to provide coverage to the needed subscriber devices. The increased power results in increased interference as the wireless signals reflect off of the various structures in the region of interest. At some point increasing power creates more problems due to the resulting interference and thus hurts the ability of subscriber devices to adequately distinguish and receive the wireless signals.

There remains a need for improved planning of infrastructure for wireless ad hoc networks.

### SUMMARY

Through understanding the surrounding environment and factoring this understanding into the placement of access points, a wireless network can be deployed that enables subscriber devices to clearly receive wireless signals throughout a region of interest. A method is disclosed comprising: determining an area of interest for deployment of a wireless ad hoc network; dividing the area of interest into a plurality of segments and forming a model for each of the plurality of segments, the model including one or more aggregate properties for wireless signal propagation through a corresponding one of the plurality of segments; analyzing the area of interest using the model for each one of the plurality of segments to determine a quality of coverage by the wireless ad hoc network at one or more locations within the area of interest; placing a wireless access point within a region of the area of interest where the quality of coverage falls beneath a predetermined threshold; and transmitting data across the wireless ad hoc network using the wireless access point. The model may comprise information on one or more of street furniture, height plans, clutter limits, foliage, and rooftop diffraction. The analyzing may comprise planning street level interactions between nodes in the wireless ad hoc network in one of the plurality of segments. The analyzing may comprise computing spanning network connectivity. The analyzing may comprise Monte Carlo analysis of the quality of coverage. The process may include analyzing the quality of coverage based on the wireless access point which was placed. The model may comprise information on one or more of demographics, usage, and spectrum availability. The placing of the wireless access point may be accomplished by forming a grid of multiple grid sections; searching within each of the multiple grid sections for a possible placement of the wireless access point; and placing the wireless access point within one of the multiple grid sections. A search box may be formed at a center of one of the multiple grid sections and the wireless access point is placed in the search box. The multiple grid sections may correspond to the plurality of segments. The process may include validating the wireless ad hoc network within one of the plurality of segments wherein validating comprises modifying the model for the one of the plurality of segments and analyzing the model which was modified for the quality of coverage. The modifying the model may comprise one or more of modifying grid parameters, modifying wireless access point placement, and deforming radio frequency propagation. The validating may further comprise quantifying a number of additional wireless access points needed to reach the quality of coverage which was previously calculated during the analyzing. The wireless access point may be placed within a search box where the search box is centered at a location of greatest coverage need. The process may include analyzing the model for one of the plurality of segments based on mobile wireless access points within the one of the plurality of segments. The analyzing may further comprise computing spanning network connectivity considering the presence of the mobile wireless access points and one or more of routes for the mobile wireless access points and density of the mobile wireless access points.

In embodiments, a computer program product embodied in a computer readable medium that, when executed, may analyze wireless communication by performing the steps of: determining an area of interest for deployment of a wireless ad hoc network; dividing the area of interest into a plurality of segments and forming a model for each of the plurality of segments, the model including one or more aggregate properties for wireless signal propagation through a corresponding one of the plurality of segments; and analyzing the area of interest using the model for each one of the plurality of segments to determine a quality of coverage by the wireless ad hoc network at one or more locations within the area of interest; and evaluating placement for a wireless access point within a region of the area of interest where the quality of coverage falls beneath a predetermined threshold. In embodiments, a system for analyzing wireless communication may comprise: a processor configured to: determine an area of interest for deployment of a wireless ad hoc network; divide the area of interest into a plurality of segments and form a model for each of the plurality of segments, the model including one or more aggregate properties for wireless signal propagation through a corresponding one of the plurality of segments; analyze the area of interest using the model for each one of the plurality of segments to determine a quality of coverage by the wireless ad hoc network at one or more locations within the area of interest; and evaluate placement for a wireless access point within a region of the area of interest where the quality of coverage falls beneath a predetermined threshold; and a display to present the placement for the wireless access point within the region of the area of interest.

Various features, aspects, and advantages of various embodiments will become more apparent from the following further description.

### BRIEF DESCRIPTION OF THE DRAWINGS

The following detailed description of certain embodiments thereof may be understood by reference to the following figures wherein:

FIG. 1 is a block diagram of a Mobile Ad Hoc Network (MANET).

FIG. 2 shows a MANET Wireless Protocol that may be used by devices within a MANET.

FIG. 3 is a block diagram of a node in a wireless ad hoc network.

FIG. 4 is a flowchart for performing initial wireless ad hoc network development.

FIG. 5 is a flowchart for performing ad hoc wireless network modifications.

FIG. 6 is a flowchart for algorithmic estimation of required spanning network density.

FIG. 7 shows an area of interest in a wireless network and the coverage by access points.

FIG. 8 is a flowchart for defining a candidate spanning network.

FIG. 9 shows a grid for placing access points.

FIG. 10 is a flowchart for adjusting spanning network coverage by further placement.

FIG. 11 is a flowchart for improving spanning network coverage by placing an access point.

FIG. 12 is a flowchart for validating a wireless network.

FIG. 13 is a flowchart for using mobile access points to provide network coverage.

### DETAILED DESCRIPTION

The present disclosure provides a description of various apparatus and techniques that facilitate wireless ad hoc network communications.

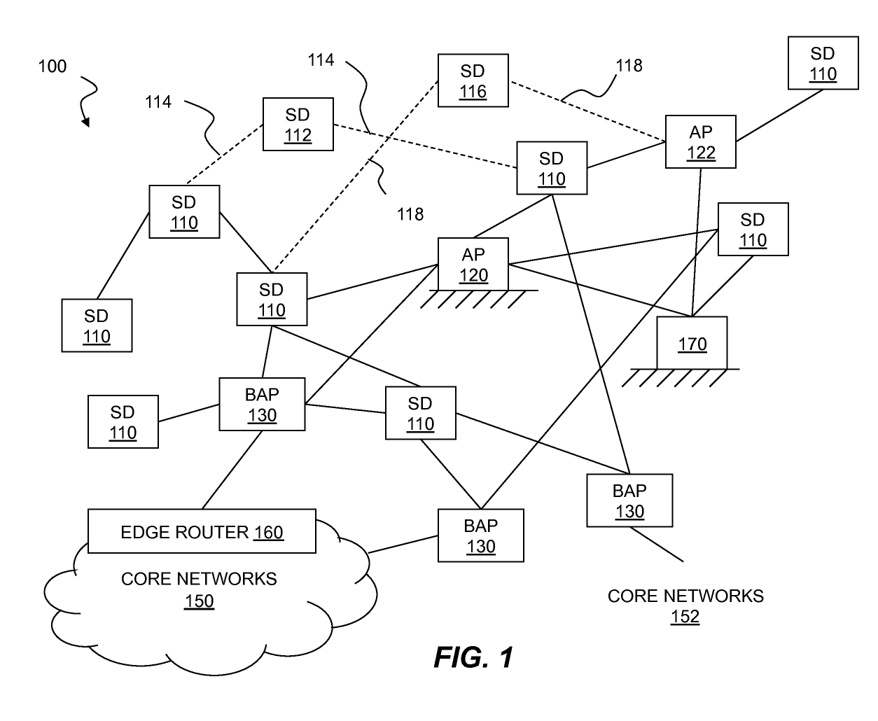

FIG. 1 shows a Mobile Ad Hoc Network (MANET) that may be used with the systems and methods described herein. In general, a MANET 100 (also referred to generally herein as a network 100) may include subscriber devices 110, access points 120, and backhaul access points 130 (for coupling to a core network 150 such as the Internet), all generally interconnected to one another as shown for example in FIG. 1. Without limiting the generality of the foregoing, one or more of the subscriber devices 110 may be a stationary device 170 that does not geographically move within the MANET 100. It will be understood that the device-to-device links illustrated in FIG. 1 are for purposes of illustration only, and in no way are intended to limit the nature or number of links between devices in the MANET 100, which may be created, removed, and/or modified over time according to any corresponding protocols followed by the devices within the MANET 100. In general, the links among devices or components within the MANET 100 are wireless links, although wired links may optionally be employed in various locations such as between the backhaul access point 130 and the core networks 150. In order to maintain the MANET 100, typically one or more protocols are shared among the participating devices to control creation, removal, and modification of individual data links between devices, and to route traffic and control information among the devices. The term protocol as used herein generally refers to any and all such rules, procedures, and/or algorithms used in maintaining the MANET 100, unless a specific protocol is explicitly stated or otherwise clear from the context.

Subscriber devices 110 may include any general purpose nodes participating in the MANET 100 according to suitable protocols. Subscriber devices 110 may, for example, include terminal nodes that send or receive data. Subscriber devices 110 may also or instead suitably be employed as intermediate nodes to route traffic to and from other subscriber devices 110. Thus an ad hoc network as described herein is generally extensible, and as new subscriber devices 110 appear within the MANET 100, they may form a part of the MANET 100 fabric that routes traffic among other nodes. A new subscriber device 112 may be introduced to the MANET 100 with new links 114 being added as the new subscriber device 112 is detected. Devices may also periodically leave the MANET 100 such as a departing subscriber device 116. As the departing subscriber device 116 leaves the network, links 118 between the departing subscriber device 116 and other subscriber devices 110, access points 122, stationary devices 170, backhaul access points 130, and/or other devices may be severed. This may occur, for example when a device moves beyond geographical boundaries of the MANET 100, when devices in the MANET are turned off (or their wireless or networking capabilities are suspended), or when a hardware or software malfunction occurs. The MANET 100 may, in a centralized or distributed manner, detect new and/or departing devices and/or links in order to maintain substantially continuous connectivity for devices in the MANET 100.

In general, a subscriber device 110 may include any network or computing device that includes a wireless interface, one or more network protocol stacks, and the like adapted to participate in the MANET 100. The Internet Protocol may usefully be employed in subscriber devices 110 within the MANET 100 in order to use well-established addressing schemes and the like. A subscriber device 110 may include without limitation a cellular phone, personal digital assistant, wireless electronic mail client, laptop computer, palmtop computer, desktop computer, video device, digital camera, electrical instrument, sensor, detector, display, media player, navigation device, smart phone, wireless networking card, wireless router (e.g., for a local WiFi network), storage device, printer, or any other device that might usefully participate in a network. In some embodiments subscriber devices may include a GPS receiver providing a position and timing reference. In embodiments, each subscriber device 110 may be authenticated and/or authorized before being granted access to the MANET 100.

Access points 120 may be provided to establish a permanent or otherwise generally stable infrastructure to the MANET 100. An access point 120 may be fixed in location or may be limited in the amount that it can move or may be a mobile access point 122 that can freely move within the MANET 100. The access points 120 may employ identical network functionality and protocol stacks as the subscriber devices 110 described above. The access points 120 may also or instead encapsulate different functionality consistent with a more specialized role in the MANET 100. In one aspect, the access points 120 may have no associated computing device that originates or consumes network traffic. That is, the access points 120 may simply form a mesh of participants in the MANET 100 and relay traffic among other network participants. An access point 120 may also include a physical connection to a power infrastructure so that it may be physically installed at a location and operate autonomously without requiring regular maintenance for battery changes and the like. In another aspect, access points 120 may include some minimal supplemental circuitry related to, e.g., status and diagnostics, or for receiving software updates and the like. By arranging a spanning network of access points 120 network continuity may be improved in areas where subscriber devices 110 are not present or are not expected to be present with any regularity. In embodiments an access point 120 may be of a size and weight making it suitable for mounting and/or concealment in a variety of locations including indoor and outdoor locations, and including mounting on walls, floors, ground, ceilings, roofs, utility poles, and so forth.

Each access point 120 may include or utilize a timing reference such as any of the Network Timing Protocols described in the Internet Engineering Task Force's Request for Comments (RFC) 778, RFC 891, RFC 956, RFC 958, RFC 1305, RFC 1361, RFC 1769, RFC 2030, and RFC 4330, all published by The Internet Engineering Task Force. Each access point may also, or instead, include a GPS receiver providing a position and timing reference, or any other open or proprietary timing system may be employed.

In embodiments the access points 120 may have a greater transmit power and/or a greater antenna gain than mobile subscriber devices 110, thus providing greater physical coverage than some other devices within the MANET 100.

The MANET 100 may include one or more backhaul access points 130 that generally operate to connect nodes within the MANET 100 to a core network 150 such as the Internet. A core network 150 may be a fixed network or may be an infrastructure network. On one interface, a backhaul access point 130 may have a wireless radio interface, one or more protocol stacks and other components of other nodes within the MANET 100. On another interface, the backhaul access point 130 may provide any suitable interface to the core network 150. The backhaul access point 130 may, for example, be deployed at a fiber access point or the like that provides high-speed data capacity for Internet traffic or the like. For example and without limitation, the fiber access point may include a Gig-E router site or an OC-3/12 add-drop multiplexer site. In an embodiment the backhaul access point 130 may include two Gig-E interfaces for backhaul connections. It will be understood that any number and variety of suitable interfaces for backhaul connections may be usefully employed with a backhaul access point 130 as described herein.

A backhaul access point 130 may serve multiple access points 120 within the MANET 100, and may distribute network load across those access points. Alternatively, a single backhaul access point 130 may serve a single access point 120. The number of access points 120 served by a backhaul access point 130 may depend on various factors such as the amount of intra-MANET traffic and extra-MANET traffic, the nature and direction of multicast versus unicast data, and so forth. This association between backhaul access points 130 and access points 120 may change from time to time depending on the presence of other subscriber devices 110 within the area, network conditions, network traffic demands, and so forth. In some cases or under some operating conditions, an access point 120 may be associated with more than one backhaul access point 130.

An edge router 160 may be included between the core network 150 and one or more backhaul access points 130. The edge router 160 may facilitate routing between the MANET 100 and the core networks 150. The core networks 150 may be connected through an edge router 160 to a backhaul access point 130 or may be directly connected to a backhaul access point 130 without going through the edge router 160. More than one edge router 160 may be used to contact multiple backhaul access points 130. In embodiments one edge router may contact multiple backhaul access points 130. The edge router 160 may include any devices or systems for maintaining connectivity between the MANET 100 and the core networks 150, and may further support or enhance network activity within the MANET 100. For example, the edge router 160 may include an industry standard and/or proprietary Address Resolution Protocol server, an application server, a Virtual Private Network server, a Network Address Translation server, a firewall, a Domain Name System server, a Dynamic Host Configuration Protocol server, and/or an Operations, Administration, Maintenance and Provisioning server, and the like, as well as any combination of the foregoing. These various components may be integrated into the edge router 160 or may be provided as separate (physical and/or logical) systems that support operation of the edge router 160. These supporting systems may in general support operations such as broadband Internet connectivity within the MANET 100, broadcast communications crossing between the MANET 100 and the core networks 150, and so forth, as well as the use of multiple backhaul access points 130 to efficiently route inter-MANET (and/or intra-MANET) traffic among subscriber devices 110.

The core networks 150 may include any network resources outside the MANET 100. As shown in FIG. 1, there may be any number of different core networks, which may for example include a second core network 152 connected to the MANET 100 through a backhaul access point 130. The second core network 152 may be wholly independent from the core network 150, or may connect to the core network 150 through a fixed or other type of network. The core networks 150 may connect disparate, geographically remote and/or local instances of the MANET 100 to form a single network. The core networks 150 may include any and all forms of IP networks, including LANs, MANs, WANs, and so on. The core networks 150 may also or instead include the public Internet, the Public Switched Telephone Network, a cellular communications network, or any other network or combination of networks for data traffic, voice traffic, media broadcasting, and so forth. In other embodiments the core networks 150 may consist exclusively of a single zone of administrative control, or a number of zones of administrative control, or some combination of an administrative zone and any of the foregoing.

The stationary device 170 may include any subscriber device 110 that, for whatever reason, does not physically move within the MANET 100. In general, such fixed physical points within the MANET 100 may provide useful routing alternatives for traffic that can be exploited for load balancing, redundancy, and so forth. This may include, for example, a fixed desktop computer within the MANET 100.

Communication within the MANET 100 may be accomplished via protocols, referred to collectively herein as the MANET Wireless Protocol (MWP). In general, any of the nodes above that participate in the MANET 100 according to the MWP may include a hardware platform enabling radio software and firmware upgrades, which may include for example a dedicated or general purpose computing device, memory, digital signal processors, radio-frequency components, an antenna, and any other suitable hardware and/or software suitable for implementing the MWP in participating nodes.

In embodiments, any of the foregoing devices such as one of the access points 120 may also include an adapter for other networks such as an Ethernet network adapter or equivalent IP network adapter, router, and the like, so that non-MANET equipment can participate in the MANET 100 through the device. It will also be appreciated that, while connections to core networks 150, 152 are shown, these connections are optional. A MANET 100 (with or without access points 120) may be maintained independently without connections to any other networks, and may be usefully employed for the sole purpose of trafficking data among subscriber devices 110.

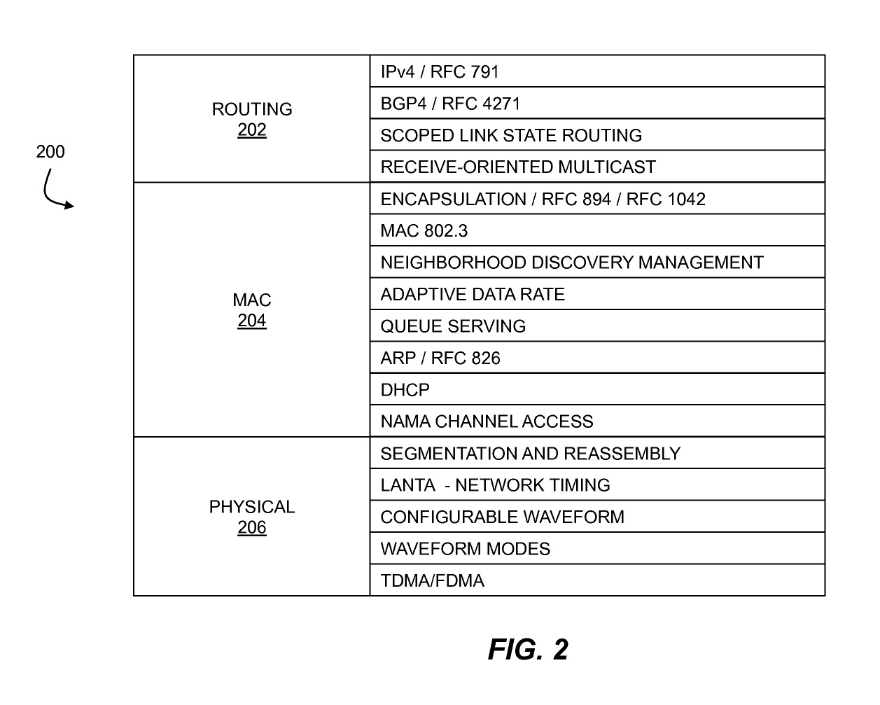

FIG. 2 shows a MANET Wireless Protocol (MWP) stack that may be used by devices within the MANET 100 of FIG. 1.

In general, a protocol stack provides a reference model for communications among network devices so that functions necessary or useful for network communications are available while each functional layer can be designed, modified, and/or deployed free from the implementation details of neighboring layers. Methods and systems disclosed herein may employ any suitable protocol stack to support wireless communications among devices. This may include, for example the Open Systems Interconnection (OSI) Reference Model (with seven layers labeled Application, Presentation, Session, Transport, Network, Data Link (LLC & MAC), and Physical) or the TCP/IP model (with four layers labeled Application, Transport, Internet, Link) along with any adaptations or variations thereof suitable for use in a MANET, or any entirely different computer network protocol design. The lower layer(s) of a protocol stack that support physical interfaces, medium access control, routing and the like may be modified to accommodate mobile wireless ad hoc networking while industry-standard protocols are supported at the routing layer (e.g., for routing at a MANET boundary and/or beyond) and above. In this manner, industry standard applications and devices may be employed within the MANET while using the MANET infrastructure to manage communication. Thus, applications designed for the fixed Internet may be deployed in the MANET, and vice versa, without requiring intervention, such as of a carrier or service provider.

In various embodiments, functions within each layer may be augmented, reduced, or modified on a device-by-device basis. For example, the functionality of each of the layers may be pruned to meet specific requirements without deviating from the scope of the invention. The function(s) of a particular layer may be implemented in software and/or hardware without deviating from the scope of the invention.

As shown in FIG. 2, the layers of a MANET Wireless Protocol (MWP) stack may include a routing layer 202, a medium access control (“MAC”) layer 204, and a physical layer 206. By way of example and not of limitation, each of these layers and the associated functions are now discussed in greater detail.

The routing layer 202 may implement industry standards for routing such as Internet Protocol version 4 (IPv4) as described in RFC 791 and Border Gateway Protocol 4 (BGP4) as described in RFC 4271. The routing layer 202 may also implement wireless ad hoc networking technologies to replace, e.g., Open Shortest Path First (OSPF) as described in RFC 2740 such as scoped link state routing and/or receiver-oriented multicast. This layer may for example support industry-standard unicast and multicast routing protocols at a boundary between a MANET and a fixed network while providing propriety unicast and multicast routing within the MANET.

The Medium Access Control (MAC) layer 204 may implement industry standards for medium access control and related functions, such as RFC 894 and RFC 1042 for encapsulation, Institute of Electrical and Electronic Engineers (IEEE)802.3 for Media Access Control (MAC), RFC 826 for Address Resolution Protocol (ARP), and RFC 2131 for Dynamic Host Configuration Protocol (DHCP). The MAC layer 204 may also implement wireless ad hoc networking technologies to replace, e.g., IEEE 802.2 LLC and IEEE 802.1q such as neighbor discovery management, adaptive data rates, and proprietary queue serving. Similarly, RFC 1661 and 2516 for Point-to-Point Protocol (PPP) may be substituted with proprietary link scheduling and/or node activated multiple access (NAMA) channel access. The MAC layer 204 may, for example, support quality of service differentiation using channel access and/or queue servicing to prioritize delay-sensitive traffic. In this layer, neighbor management may establish network entry for devices and track changes in each node's local one-hop and two-hop neighborhoods, such as through a message exchange with one-hop neighbors. The MAC layer 204 may support adaptive power control by adjusting transmit power on a link-by-link basis in a MANET in a manner that, e.g., maximizes transmission capacity while minimizing interference according to link conditions and topology. Adaptive data rates may be employed on a link-by-link basis to maximize transmission capacity according to individual link conditions. Queue servicing may provide buffers for data awaiting transmission through a physical layer 206 interface, and may incorporate differentiated quality of service. At the same time, channel access may be used to determine which node transmits in each Time Division Multiple Access (TDMA) time slot, with a schedule influenced by quality-of-service parameters.

The physical layer 206 may implement wireless technologies such as segmentation and reassembly of physical layer transmissions, local area node tracking algorithm (LANTA) network timing, and slot-by-slot configurable waveforms, as well as multiple waveform modes including time domain multiple access and frequency domain multiple access waveforms, or more generally any waveforms that support multiplexing or multiple access based on time, frequency, coding, or the like. In general network timing is also provided within the physical layer 206, and may correct time and frequency errors to ensure that all nodes are operating with a common time base. At the same time, waveform mode self-discovery may be employed so that each receiver can autonomously discover which waveform mode was sent from a transmitter.

These and other functions and details of operation of a MANET Wireless Protocol stack are described in greater detail for example in U.S. application Ser. No. 12/418,363 filed on Apr. 3, 2009, the entire contents of which are incorporated herein by reference.

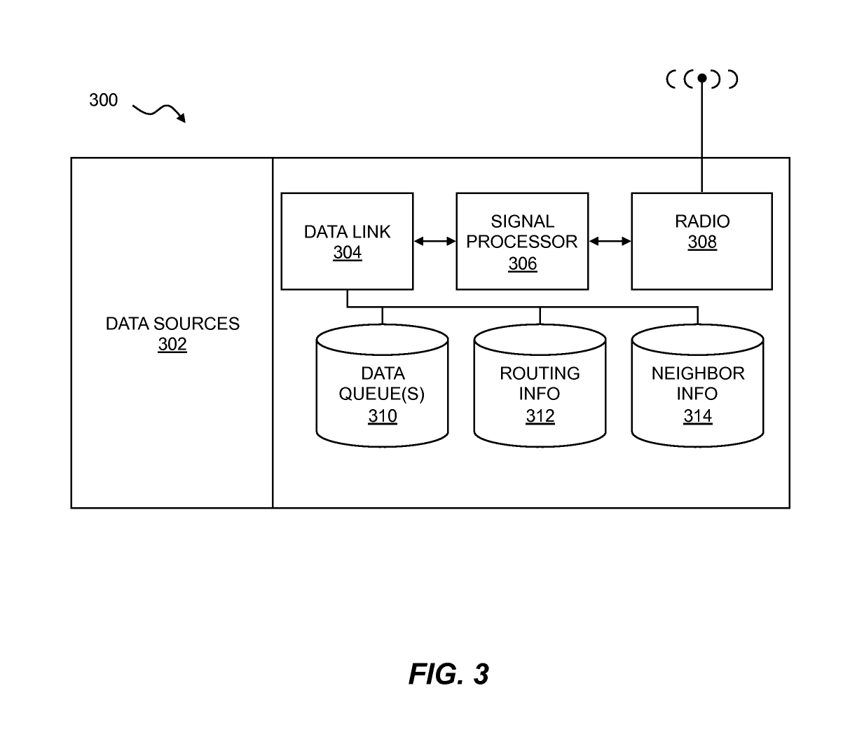

FIG. 3 is a block diagram of a node in a wireless ad hoc network such as the MANET described above. The node may be any of the devices described above, such as a subscriber device, access point, or backhaul access point. In general the node 300 may include data sources 302, a data link 304, a signal processor 306, a radio 308, data queues 310, routing information 312, and neighborhood information 314. It will be understood that the following description is general in nature, and that numerous arrangements of processing, storage, and radio frequency hardware may be suitably employed to similar affect. This description is intended to outline certain operations of a MANET node relevant to the systems and methods described herein, and in no way limits the invention to the specific architecture shown in FIG. 3.

The data sources 302 may include any applications or other hardware and/or software associated with the node 300. This may include, for example, programs running on a laptop or other portable computing device, a web server or client, a multimedia input and/or output sources such as a digital camera or video, and so forth. More generally any device, sensor, detector, or the like that might send or receive data may operate as a data source 302 in the node 300. It will be further understood that some nodes such as access points 104 may not have independent data sources 302, and may function exclusively as MANET 100 network elements that relay data among other nodes and/or provide network stability as generally described above.

The data link 304 may include hardware and/or software implementing data link layer functionality such as neighbor management, segmentation and reassembly of data packets, Quality of Service (QoS) management, data queue servicing, channel access, adaptive data rates, and any other suitable data link functions. In general, the data link 304 controls participation of the data sources 302, and more generally the node 300, in a MANET. It will be understood that the data link 304 in FIG. 3 may implement any number of lower layer (e.g., physical layer) or higher layer (e.g., routing, transport, session, presentation, application) protocols from a conventional Open Systems Interconnection (OSI) Model, or any such protocols and related functions may be implemented elsewhere within the node 300, such as in an IP stack executing on the data source 302, or in firmware within the signal processor 306 or radio 308, or in additional functional blocks not depicted in FIG. 3. For example, routing protocols may be implemented within hardware/software of the data link 304 in order to ensure that nodes in the MANET 100 share appropriate routing functions. Thus it will be appreciated that while the certain elements discussed herein might suitably be placed within the data link layer of a formal protocol stack, the systems and methods of this disclosure might also or instead be implemented with variations to a conventional protocol stack, or without any formal protocol stack whatsoever.

The data link 304 may include a link manager that collects neighbor information from the data link layer, and may form and maintain the neighborhood information 314 for the node 300. This table may be used to establish routes to neighbors, and may be updated periodically with information from one and two hop neighbors as described further below. The link manager may monitor statistics on all active links for a node on a link-by-link basis in order to support link quality calculations and other functions described herein. The term metadata is used herein to generally refer to the neighborhood information 314 for the node 300 or any other information characterized one or more nodes, data links, or other network characteristics that might be shared among nodes to describe the network in which nodes are participating and communicating. In general, the metadata includes at least one item of metadata, although any number of metadata items might be usefully employed according to the number of nodes in a neighborhood and the amount of information to be exchanged among nodes.

The signal processor 306 may include any signal processing circuitry for waveform processing and timing functions associated with transceiving data at the node 300. This may include, for example, network timing, time-slot and/or frame-based waveform configuration, maintenance of one or more families of Orthogonal Frequency Division Multiplexing waveform modes (or other transmit mode waveforms), receiver detection of waveform modes, error correction coding, and so forth. In general, the signal processor 306 may be implemented in any suitable combination of digital signal processors, field programmable gate arrays, application-specific integrated circuits, microprocessors, or other general or special-purpose computing devices, as well as any other combination of digital and/or analog electronics useful for the various signal processing functions described herein.

In one embodiment, a family of Orthogonal Frequency Division Multiplexing (OFDM) waveforms may be employed for adaptive data rate communications. The modes of the OFDM waveforms may, for example, include 7.2 MHz Quadrature Phase-Shift Keying (QPSK), 4.8 MHz QPSK, 2.4 MHz QPSK, 1.2 MHz QPSK, 1.2 MHz Binary Phase-Shift Keying (BPSK), or the like. The effective data rate for transmit waveforms may be affected by other parameters such as error correction. In order to facilitate implementation of an adaptive rate system, the transmit modes may be organized into an ordered list of monotonically increasing data rates matched to correspondingly decreasing signal robustness, thus permitting unique mapping of link quality to transmit mode. In one aspect, the actual waveform mode selected to transmit data on a link may be adaptively selected according to any suitable evaluation of link quality for links to neighboring nodes.

The radio 308 in general operates to transmit data from the data queue(s) 310, as organized and encoded by the data link 304 and the signal processor 306 (along with any control information, packet header information, and so forth), over a wireless air interface to other nodes in a MANET, and to perform complementary data reception. The radio 308 may include any radio frequency analog circuitry and the like, and may be coupled to the signal processor 306 which converts data and control information between a digital representation used within the node 300, and an analog representation used in radio frequency communications with other nodes. In embodiments, a low power radio 308 may be employed, such as where the node 300 is a battery-powered mobile device. In other embodiments, a high-power radio 308 may be employed, such as where the node 300 is an access point or backhaul access point connected to a fixed power infrastructure. In an embodiment, the radio 308 and signal processor 306 provide adaptive data rate coding capable of changing transmit modes, error correction, and the like according to measured link quality.

The data queue(s) 310 may include any data for transmission from the node 300. This may include, for example, data from the data sources 302, data that is relayed by the node 300 from other nodes in the MANET, and/or control information scheduled for transmission within data packets from the node 300. The data queue(s) 310 may be organized in any suitable fashion, and may include a single first-in-first-out queue, multiple queues, prioritized queues, and the like. In one embodiment, the node 300 may include multiple prioritized queues to assist in providing various service levels, such as for QoS traffic. In general, data in the data queue(s) 310 is delivered according to any suitable queuing mechanism to the data link 304, signal processor 306, and radio 308 for transmission within the MANET.

Routing information 312 such as a routing or forwarding table may be provided to support routing functions by the node 300. In general, this may include, for example, a destination address or identifier, a cost of a path to the destination (using any suitably cost calculation), and a next hop on that path. Other information such as quality of service and other metrics for various routes and links may also be provided for more refined routing decisions.

Neighborhood information 314 may be maintained in a database, flat file, routing table, or other suitably organized volatile or non-volatile storage within the node 300. The neighborhood information 314 generally supports the creation and maintenance of the MANET as well as routing functions of each MANET node. Within the MANET, each node may interact with other nodes to autonomously identify and maintain local network connections, shift capacity, dynamically form routes throughout the network, and so on. The routing functions of the node (as supported by the neighborhood information 314) may accommodate delay-sensitive (e.g. voice) traffic, delay-tolerant traffic with quality of service (QoS) prioritization, and so on.

The neighborhood information 314 may include an identification of neighboring nodes along with information relating to those nodes. This may include one-hop neighbors (i.e., neighboring nodes in direct wireless communication with the node 300), two-hop neighbors (i.e., neighboring nodes that communicate with the node 300 through only one other node), or any other nodes or participants within the MANET. In one aspect, neighborhood information 314 includes link quality information for the radio 308, which may be obtained from any combination of physical layer and data link data, and may be employed to adapt the data rate of communications according to currently present channel conditions. The neighborhood information may also include QoS data used to select next hops for QoS data. Other useful information may include bandwidth utilization, node weights, node position (either logical or physical), and queue latency for each QoS type and/or other priority type.

In one aspect, the neighborhood information 314 may be gathered during periodic exchanges (such as during control transmissions) with neighboring nodes, which may occur under control of the link manager of the data link 304. For example, the node 300 may determine output bandwidth (i.e., data transmit requirements) for each link that the node 300 has with a neighbor, and may transmit this to one-hop neighbors. Similarly, the node 300 may receive output bandwidth from each one-hop neighbor. Using this data, each node 300 may further calculate its own input bandwidth (i.e., data receive requirements) from each link to a neighboring node, and this information may in turn be exchanged with one-hop neighbors. Following a system-wide exchange with one-hop neighbors, the node 300 (and every other node in the MANET) may calculate a node weight that represents relative output requirements for the node 300. For example, the node weight, W, may be calculated as:

$$W = \frac{{BW}_{out}}{{BW}_{out} + {BW}_{in}} \qquad [ Eq . 1 ]$$

where BWₒᵤₜ is the total output or transmit requirements for each link of the node 300, and BWᵢₙ is the total input or receive requirements for each link of the node 300. Finally, the node 300 may transmit the node weight to each neighboring node, and may in turn receive a node weight from each neighboring node. It will be appreciated that the node weight, W, may be further processed for use with other neighborhood information 314, such as by limiting the value according to the number of bits used for control information, or by providing a supplemental adjustment to the node weight to further refine control of routing or other MANET functions. Sharing of information for maintenance of the neighborhood information 314 may be controlled, for example, by the data link 304, which may apply any suitable technique to determine when to share information with one hop neighbors. In one aspect, the data link 304 may transmit data whenever a change is detected in the MANET such as an addition or deletion of a node.

As noted above, any of the neighborhood information 314, routing information 312, and/or data queue(s) 310, as well as status or other information concerning any of the foregoing, may usefully be shared among the nodes participating in a network, and all such information is intended to fall within the meaning of metadata as that term is used herein.

In another aspect, for a MANET that has location-aware nodes 300 (e.g., using Global Positioning System (GPS) data, signal strength data, and so forth), the neighborhood information 314 may include position data in order to support location-based routing and the like.

It will be understood that while a MANET is described as one useful platform for wireless ad hoc networking, any system with capabilities to support the systems and methods described below may also or instead be employed, including without limitation Mobile Broadband Routable Internet systems as described in U.S. application Ser. No. 12/418,363 filed Apr. 3, 2009. Having described a suitable type of wireless ad hoc networking in general terms, the description now turns to a more detailed treatment of set top boxes with wireless ad hoc networking capability.

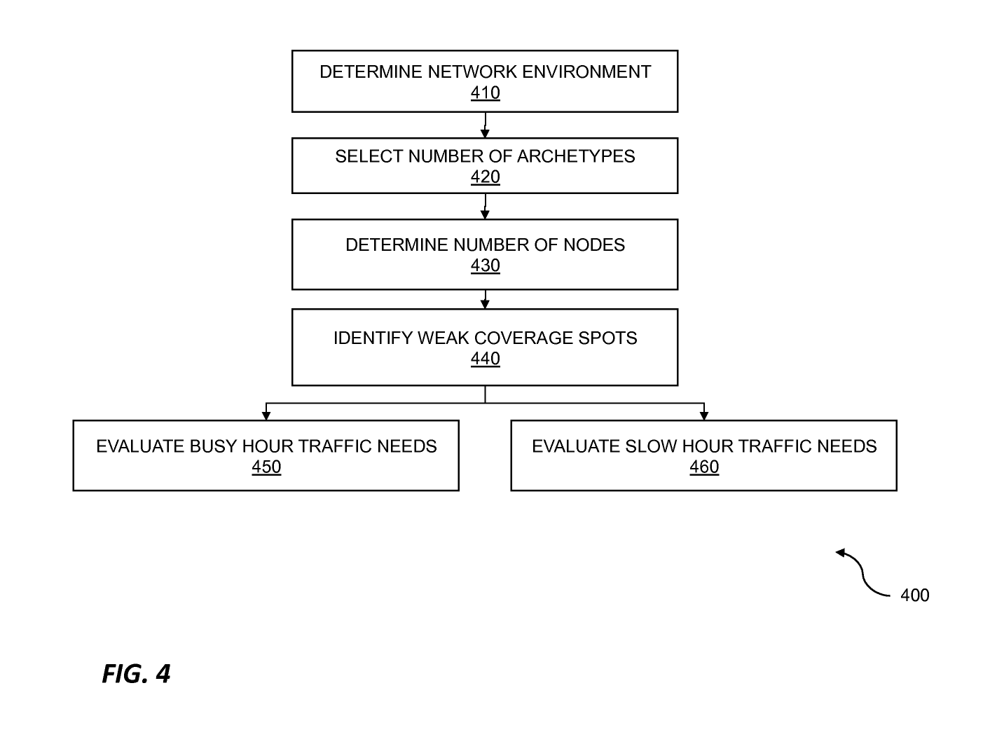

FIG. 4 is a flowchart for performing initial wireless ad hoc network development. The process 400 begins by determining the environment of the MANET (step 410). The environment may include the street pattern, the building locations and heights, the foliage coverage, the rooftop diffraction models, and other aspects of the surrounding region that impact wireless communication signals. The environment may further include street furniture, such as street lights and other structures on which access points may be placed. Natural and man-made objects may be included in the environment as obstructions and surfaces which may reflect or absorb wireless signals.

The number of archetypes may be selected (step 420). An archetype may include datasets of information that pertains to wireless communications such as models for street furniture, height plans for the geography, height plans for the buildings, items which provide clutter to the wireless signals, and similar relevant subjects. The selection of the number of archetypes allows a determination of the level of fine grain analysis which is possible. With a smaller number of archetypes, the computation requirements are smaller. With a larger number of archetypes, a higher level of detailed analysis is possible. Archetypes may include static attributes selected from, e.g., geographical data obtained through cluster analysis. The model or models may comprise information on one or more of street furniture, height plans, clutter limits, foliage, and rooftop diffraction.

The number of wireless nodes may be determined (step 430). This may include a current number of wireless nodes, access points, and the like. A desired number of wireless nodes may also be determined. Further a prediction of the number of nodes expected within a given period of time may be determined. Determining the number of nodes may include determining the number of backhaul access points (BAPs), MANET access points (MAPs), mobile nodes, and the like.

Weak spots within the MANET may be identified (step 440). These weak spots may be regions where coverage is low and thus there is a concern about this location. The concern locations may alternatively be locations where current wireless traffic is excessively high, which may be referred to as hot spots. The hot spots or weak spots may be a function of the number of nodes and the environment of the wireless network and the models of the surrounding structures. The hot or weak spots may be known locations of concern or they may be predicted locations, based on appropriate modeling of the wireless network.

The information and analysis gleaned thus far in process 400 may be used to understand the impact during busy and slow traffic times. Evaluation of busy hour traffic needs (step 450) may be based on the wireless traffic when critical information is being communicated, when continuous wireless traffic of network backups is performed, or when heavy usage is expected due to large numbers of subscriber devices being present. Busy hour traffic may be times when natural or man-made disasters occur and numerous individuals are trying to simultaneously communicate. Busy hour traffic may also simply be during commute times within a city when people are trying to wrap up business from the day and plan an evening's activities. Different numbers of nodes and capabilities may be required during busy hour traffic.

Slow hour traffic needs may be evaluated (step 460) in order to understand needs during late night or early morning time frames, weekends, holiday periods, or other times when node density may be low. Identifying slow hour traffic needs may be helpful for a number of purposes related to network planning, such as determining when maintenance on a wireless network can be performed with minimal disruption, or determine where fixed access points might be needed to maintain a spanning network.

Analysis performed by process 400 may be repeated as various archetypes are added. Analysis may also be performed where a quick determination is needed and a “good enough” solution is usable. For example data may be collected on four cities and extrapolation of these four cities may allow analysis of other metropolitan areas or of a larger geographic region such as a state or country. Further, analysis may include an investigation of demographics of the users of nodes or subscriber devices in the wireless network. Individual usage may be factored in as well. Additionally, spectrum availability for possible use by the wireless networks may be considered. Each of these considerations may be incorporated into archetypes as desired. A model may comprise information on one or more of demographics, usage, and spectrum availability.

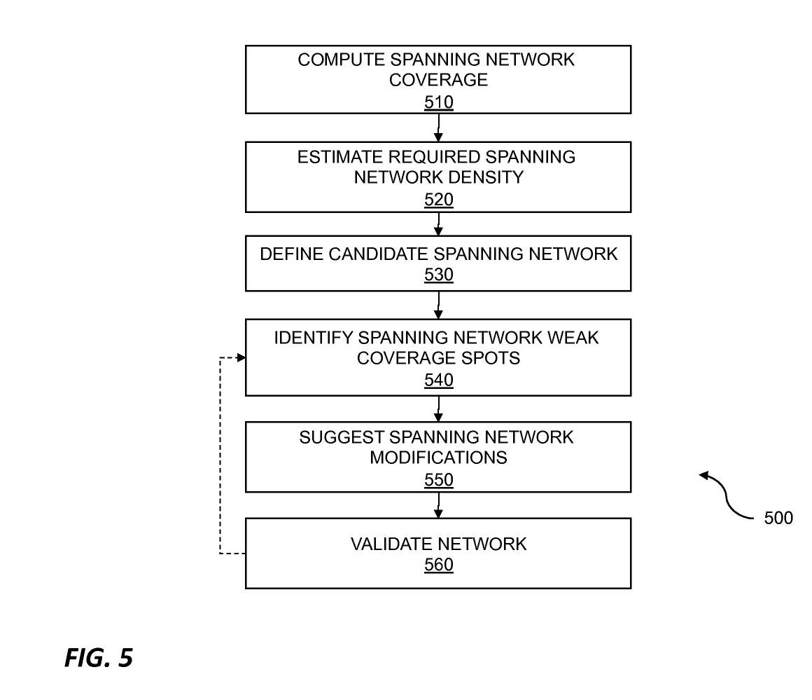

FIG. 5 is a flowchart for performing ad hoc wireless network modifications. This flow may be implemented on a computer for simulation and evaluation. The process 500 begins with computing the spanning network coverage (step 510). Determining a spanning network may include identifying a supportable data rate desired across the network and may further include a determination of routes to and from a fixed network such as through a backhaul access point. A spanning network may accurately model site-specific impacts from the surrounding environment on wireless signal propagation. Spanning network coverage may be determined for or at a single access point or single backhaul access point or may include multiple access points or backhaul access points. An existing spanning network may be evaluated based on the number of nodes present and the possible connections between the nodes. Multiple hops across the network may be allowed to communicate between various nodes and thus multiple edges within the network may be traversed. Based on the nodes present and the environment, a quality of coverage may be calculated. The factors include the buildings present, their respective heights, foliage, and other possible inputs. Link data rates may be determined for communicating information between nodes. Connectivity may be evaluated between nodes based on possible node power and obstructions to communication signals. In some embodiments, an existing spanning network may not already exist and step 510 may be skipped so that the following step in process 500 may be the starting point.

An estimate of the required spanning network density (step 520) may be performed. Based on the various features of the network and the environment in which the network operates, a network density may be estimated. The number of nodes required and the number of links between the various nodes may be estimated. Further, the link data rate for each of the links and, where multiple hops are needed, cumulative data rates which may be achieved may be estimated.

A candidate spanning network may be defined (step 530). In some embodiments an arbitrary spanning network may be chosen as a starting point for evaluation. Based on the number of nodes estimated in step 520, a random placement of the nodes may be used as a candidate spanning network. Alternatively, based on previous experience with other regions, a spanning network previously used for another region may be chosen as the starting candidate or as a basis for the starting candidate.

The candidate spanning network may be evaluated to identify coverage holes within the network area (step 540). The coverage holes may be areas where no wireless coverage is obtained or, alternatively, a coverage hole may be defined to be a low quality of coverage. A coverage hole may be a spot where only weak wireless signal may be observed. One or more coverage holes in the network may be observed and these may be ranked for priority. The coverage holes may be ranked based on size of each of the coverage holes, based on a critical region such as the presence of a hospital or police station, or based on a particularly weak signal strength.

A suggested modification to the spanning network (step 550) may be obtained. A modification may be based on a coverage hole identified in step 540. A modification may be the addition of an access point or it may be a movement of an access point or some other change to the network. The modification may be an addition or movement of any of the network elements. The suggestion may be based on an algorithmic determination or it may be based on a user input to the system. A modification may further involve a modified amount of power allowable by a given node and may even be a change from a battery or alternatively powered node to a node powered off of an existing grid.

The spanning network as modified may be validated (step 560). Validation may include evaluation of network coverage. The network coverage may look for improvement over the previous network configuration coverage. Alternatively, validation may evaluate coverage to ensure that coverage did not degrade more than a specific amount over a previous network configuration. Since spanning networks may have certain non-linear characteristics, optimization may involve modifications to get past a local minimum in order to find far better solution. Validation may consider size of coverage holes which remain. Validation may further evaluate placement to network elements to ensure that the chosen locations are allowable. One example of an invalid location would be the placement of an access point in the middle of a street where no building exists nor lamp post could be placed to support the access point's placement.

Based on the results of the validation, process 500 may branch to identify spanning network coverage holes (step 540). Alternatively, if the results of the validation step 560 are sufficiently positive the current configuration of the spanning network may be considered adequate for usage and implementation.

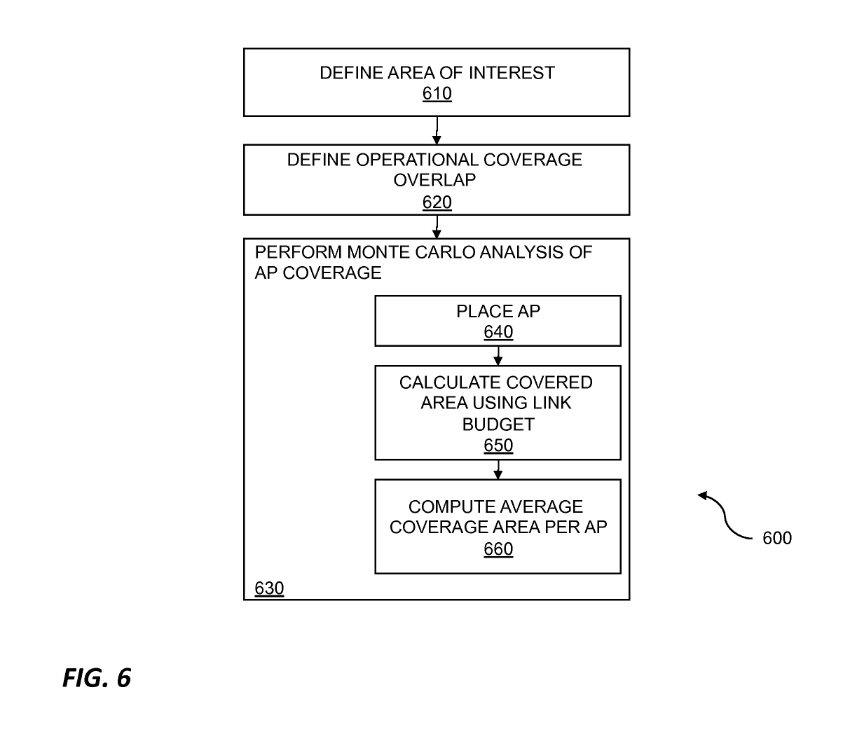

FIG. 6 is a flowchart for algorithmic estimation of required spanning network density. The process 600 may include aspects previously discussed in step 520. Process 600 may begin with defining an area of interest (step 610). A physical region may be determined or a geographical area. Likewise a region may be sub-divided into smaller areas and those areas may be determined to be areas of interest. Such are area of interest may include a city, an island, a state, or even a country. The process may include analyzing which comprises computing spanning network connectivity.

An operational coverage overlap may be defined (step 620). Such an operational overlap may include determining access points where another node may communicate over the wireless network and reach more than a single access points. In some embodiments a coverage overlap may be nominally defined to be 30%. In this example one access point's wireless coverage may overlap with 30% of a neighboring access point's coverage. A user may provide input defining the desired coverage overlap or the overlap may be determined algorithmically based on time to hand off from one access point to another, based on known wireless obstruction concerns, or based on requirements of subscriber devices within the area of interest.

A Monte Carlo analysis may be performed of access point coverage (step 630). Any access point may be used as a starting point for analysis or a backhaul access point may be used as a starting point. The Monte Carlo analysis may include randomly placing access points or randomly moving access points to determine the impact on the operational coverage.

In some embodiments, an access point may be placed (step 640) within the area of interest. The placement may be randomly within the area of interest or may only be random within a specified grid subdivision of the area of interest.

The coverage of the placed access point may be calculated (step 650). The coverage may be based on a link budget where connection links between the placed access point and other nodes may have limits specified on the amount of traffic which the links can carry.

An average area for coverage may be computed on a per access point basis (step 660). The area may be determined based on square meters, square feet, or some other area metric. The area may also be determined based on a percentage basis relative to the area of interest. The process may include analyzing which comprises Monte Carlo analysis of the quality of coverage.

Repeated access point placement may be performed as part of the Monte Carlo analysis. The analysis may be repeated until a certain quality metric is achieved such as a high enough coverage area per access point. The number of access points which need to be placed may be estimated based on the area of interest and the average coverage area. In some embodiments the number of access points may be estimated according to the Eq. 2. N_{AP} is the number of access points. AreaOfInterest is an area measurement of the region known as the area of interest. AverageCoverageArea is an area measurement of the average coverage area for an access point. Overlap is a fractional measurement of the overlap from one access point to its neighbor.

$${N}_{AP} = \frac{AreaOfInterest}{( AverageCoverageArea ) * ( 1 - Overlap )} \qquad [ Eq . 2 ]$$

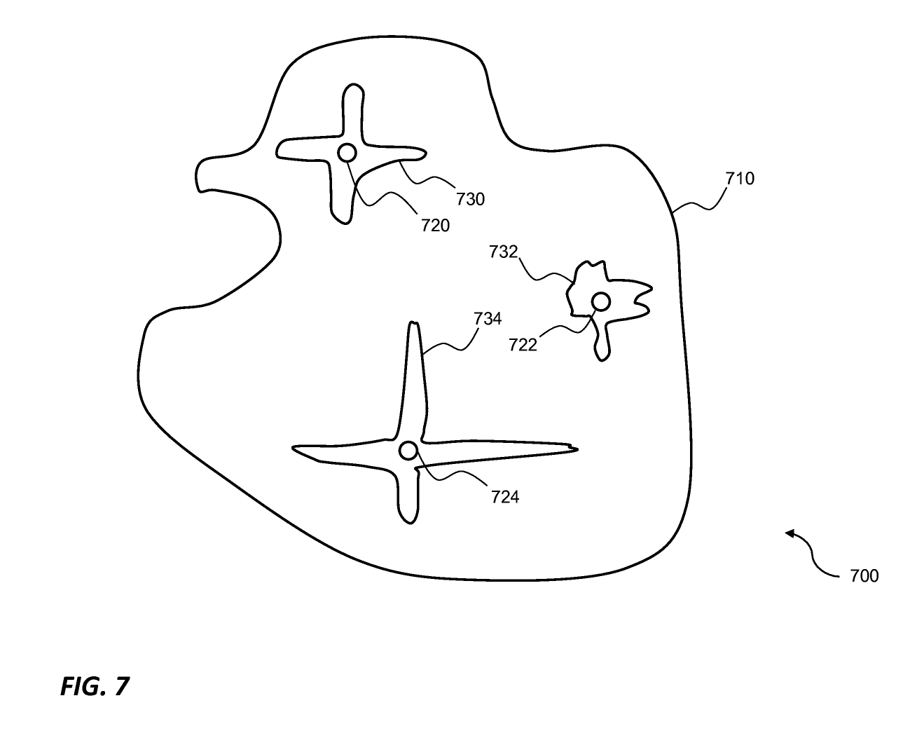

FIG. 7 shows an area of interest in a wireless network and the coverage by access points. The process may include determining an area of interest for deployment of a wireless ad hoc network. An area of interest is shown by shape 710. An area of interest may be a regular shape such as a circle, square, or rectangle. Likewise an area of interest may be an irregular shape, such as the shape of an island, a series of streets, a border of a park or the like. An access point 720 is shown along with a corresponding coverage area 730. A coverage area may be defined to be a region where a certain wireless signal strength is detectable. Likewise a coverage area may be a region where any wireless signal strength is detected. Further, a coverage area may be a region where wireless signal is and interfering signals are below a certain threshold. A coverage area may be a function of the surrounding environment including, but not limited to, buildings and other obstructions. A coverage area may be irregular due to street patterns, surrounding buildings, and other factors. A second access point 722 is shown with a corresponding coverage area 732. A third access point 724 is shown with a corresponding coverage area 734. Coverage areas may overlap (not shown). Coverage area overlap may be desirable so that when mobile subscriber devices are receiving signal from one access point and move toward another access point, good signal may continuously be received and no loss of communication encountered. Likewise, predicted coverage area overlap may be desirable so that when additional interference signals are encountered, there are no resulting gaps in reception. Likewise, when other factors change, such as foliage growth or atmospheric changes, such as rain, sleet, or snow, predicted areas of overlap are useful.

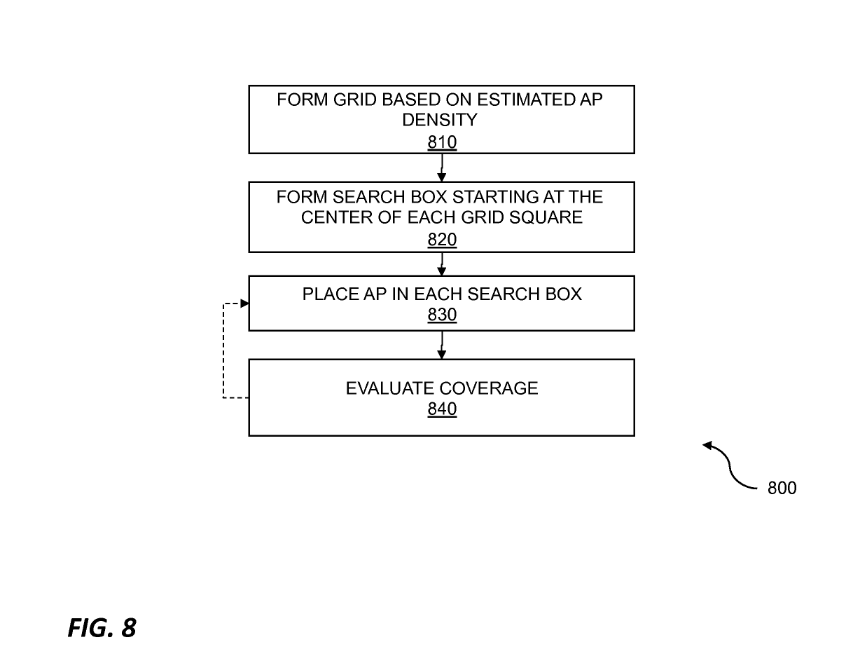

FIG. 8 is a flowchart for one embodiment of defining a candidate spanning network. Process 800 begins by forming a grid based on an estimated access point density (step 810). The process may include dividing the area of interest into a plurality of segments and forming a model for each of the plurality of segments, the model including one or more aggregate properties for wireless signal propagation through a corresponding one of the plurality of segments. One means of determining an estimated access point density is based on step 520. An alternative embodiment determines access point spacing based on Eq. 3. The average coverage area may be determined from step 660. The percent overlap may be defined by step 620. An area of interest may be divided up by a grid. The grid spacing may match the access point spacing as determined above. The placing of the wireless access point may be accomplished by forming a grid of multiple grid sections. Spacing_{AP} is the spacing between access points and may also be the distance between grid lines.

Spacing_{AP}=\sqrt{AverageCoverageArea×(1−Overlap)} [Eq. 3]

A search box may be formed starting at the center point of each grid square (step 820). The search box may be smaller than the grid spacing. In some embodiments, the search box may be formed to avoid certain obstacles. The search box may be formed so that sufficient overlap exists in coverage between access points. The process may include searching within each of the multiple grid sections for a possible placement of the wireless access point. A search box may be formed at the center of one of the multiple grid sections and the wireless access point is placed in the search box.

An access point may be placed in each search box (step 830). The process may include placing a wireless access point within a region of the area of interest where the quality of coverage falls beneath a predetermined threshold. An access point may be placed near the center of each search box. Alternatively each access point may be placed based on analyzing the associated search box for obstructions, available street furniture, possible buildings, and the like. The process may include placing the wireless access point within one of the multiple grid sections. The multiple grid sections may correspond to the plurality of segments.

The wireless network coverage may be evaluated (step 840). A quality metric for the wireless signal reception may be used to determine the wireless network coverage. The process may include analyzing the area of interest using the model for each one of the plurality of segments to determine a quality of coverage by the wireless ad hoc network at one or more locations within the area of interest. The coverage evaluation may identify needed improvements. Information on the needed improvements may be factored into placement of the access points. The placement may be updated for needed search boxes and step 830 may be repeated, based on the updated information. Alternatively, if coverage is deemed to be sufficient, process 800 may be completed. The process may include analyzing the quality of coverage based on the wireless access point which was placed. The process may further include transmitting data across the wireless ad hoc network using the wireless access point. The analyzing may comprise planning street level interactions between nodes in the wireless ad hoc network in one of the plurality of segments.

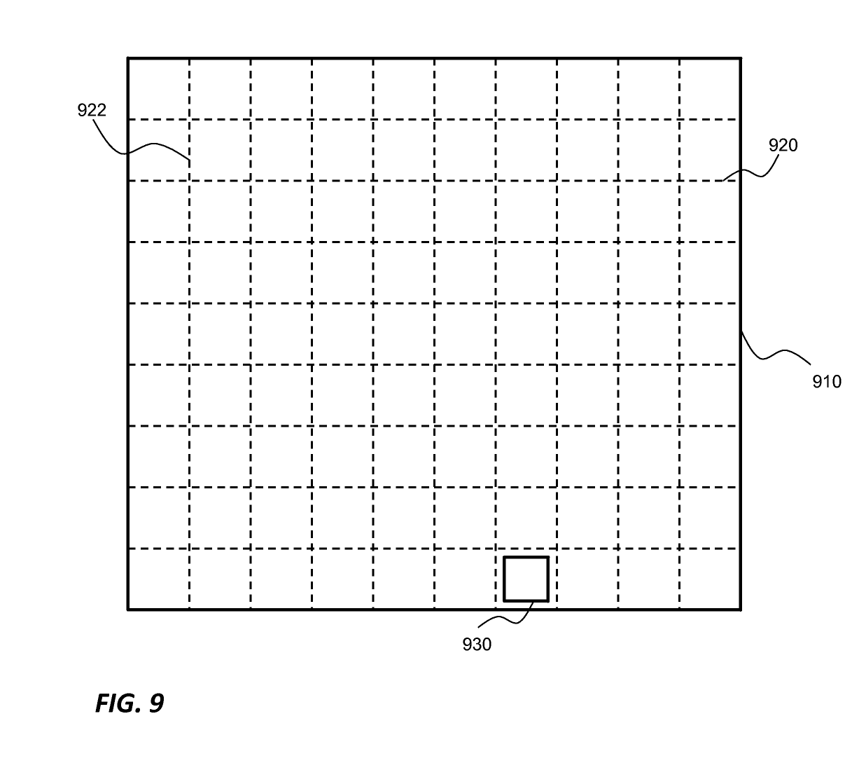

FIG. 9 shows a grid for placing access points. FIG. 9 shows a grid formed according to the process 800. An area of interest 910 is shown. A grid formed of horizontal lines 920 and vertical lines 922 is placed over the area of interest. The spacing between grid lines may be based on access point spacing as described in step 810. A search box 920 is shown centered at one of the grid squares.

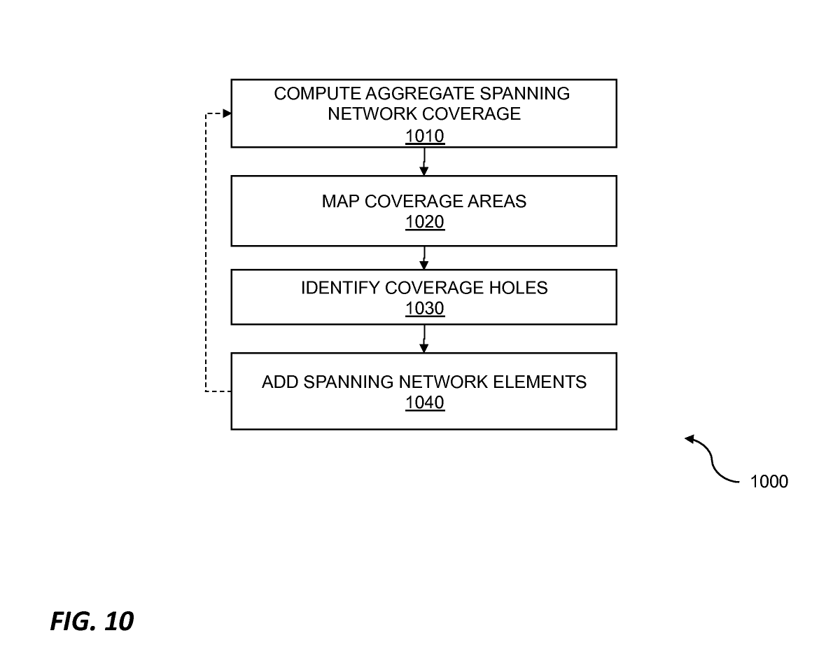

FIG. 10 is a flowchart for adjusting spanning network coverage by further placement. Process 1000 begins by computing the aggregate spanning network coverage (step 1010). The spanning network coverage may be calculated based on the location of access points in an area of interest. The coverage may further be calculated based on the presence of obstructions and interference in the environment. Other factors, including foliage density and the like may be considered in the coverage calculation. Wireless coverage may be defined as areas where some level of wireless signal may be received. In some embodiments Rician analysis may be performed to determine where wireless signals fade and thus, in turn, use this information to determine the network coverage.

The coverage areas may be mapped (step 1020). Over the area of interest, locations where coverage exists may be displayed or described. This mapped coverage data may be stored for later use.

Areas where coverage holes exist may be identified (step 1030). Coverage holes may be defined as areas where there is no wireless reception for the network or where reception is below a certain level of quality. In some embodiments, a coverage hole may be defined to be a region where heavier traffic is expected than existing access points may be able to handle.

Spanning network elements may be added (step 1040) where coverage holes exist. The spanning network elements may include access points, backhaul access points, MANET access points, and similar items which may assist in wireless network coverage. Based on the added spanning network elements, the aggregate spanning network coverage may be computed, thus branching back to step 1010. Once sufficient coverage is achieved, process 1000 may be completed. An example target coverage may be 95%. Alternatively, a targeted growth in the number of access points or other network elements may be used as the way to know when to exit process 1000.

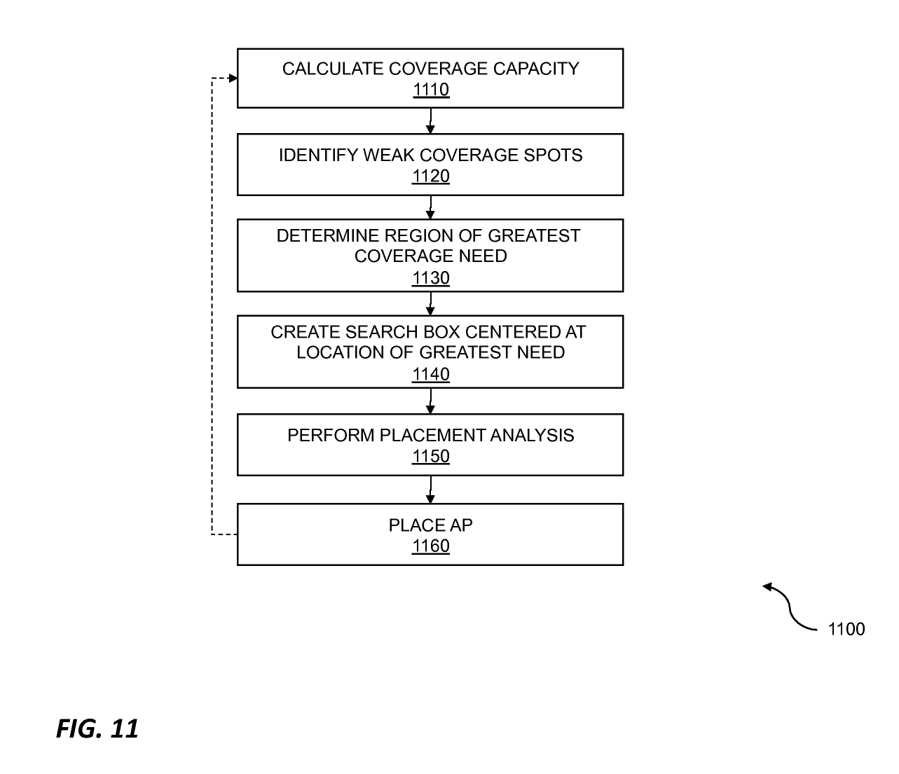

FIG. 11 is a flowchart for improving spanning network coverage by placing an access point. Process 1100 may begin by calculating a coverage capacity (step 1110) of a wireless network. Coverage may be defined within an area of interest by the amount of area which has a certain quality of wireless signal reception.

As shown in step 1120, weak coverage spots may be identified. These weak coverage spots may be areas over which wireless signal strength is low. Alternatively, weak coverage spots may be areas where heavy wireless traffic exists or is expected and thus “hot spot” may be an apt term as well.

A region over which the greatest coverage need may be determined (step 1130). A greatest coverage need may be due to a low number of access points or due to a large number of subscriber devices. Greatest coverage need may also be determined based on criticality of communication, such as due to emergency services or the like.

A search box may be created at the location of greatest need (step 1140). The search box may be centered at the geometrical center of the location of greatest need. Alternatively, the search box may be placed in order to avoid certain obstructions or may be placed in order to take advantage of known structures where access points may be placed. The wireless access point may be placed within a search box where the search box is centered at a location of greatest coverage need.

A placement analysis may be performed (step 1150). The placement analysis may look for structures, such as street furniture, where access points may be located. Likewise, placement analysis may factor in obstructions and key areas where coverage is desired. As discussed earlier coverage areas may favor paths along streets and thus placement of an access point to take advantage of a street path may be useful. Placement analysis may include identifying a “most open” spot within a search grid. This most open spot may provide the best coverage within a coverage weak spot. Alternatively a most open spot may be the easiest location at which to place a network element.

An access point may be placed (step 1160). The access point may be physically placed or may be placed in a simulation in order to better compute the impact of the placed access point and thus determine estimated coverage.

Based on the calculated coverage capacity process 1100 may be repeated until a desired coverage capacity is achieved. Alternatively, process 1100 may be repeated until a specific number of access points have been placed.

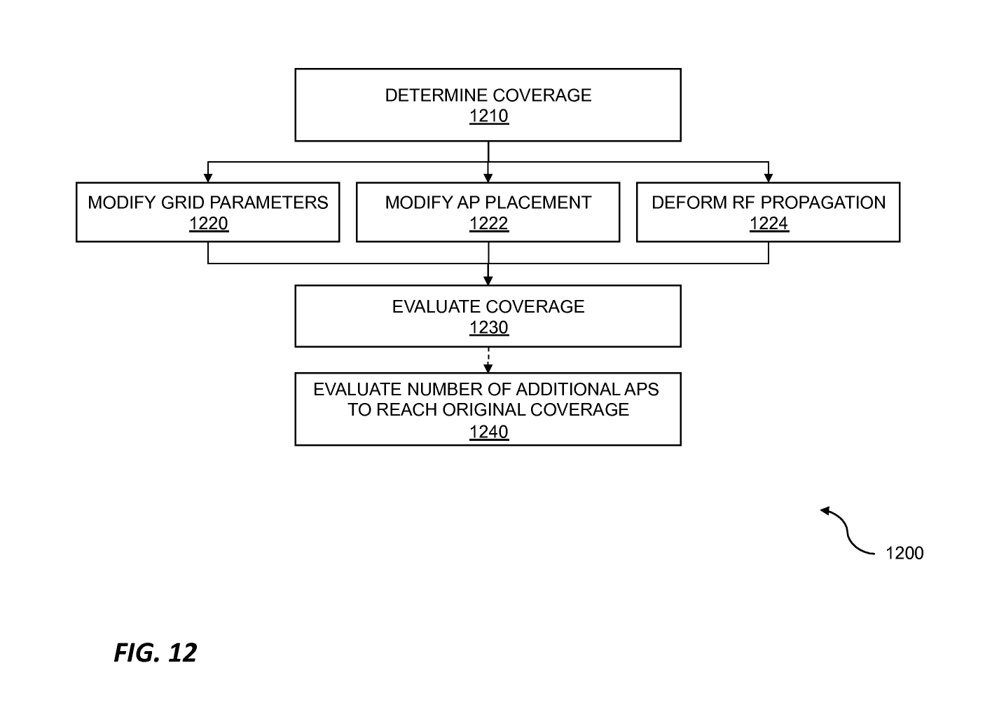

FIG. 12 is a flowchart for validating a wireless network. Process 1200 is one embodiment for validating a wireless network. Process 1200 begins by determining coverage (step 1210) within a wireless network. The coverage may be a metric of quality for wireless signal over an area of interest. The process may include validating the wireless ad hoc network within one of the plurality of segments wherein validating comprises modifying the model for the one of the plurality of segments and analyzing the model which was modified for the quality of coverage. The modifying the model may comprise one or more of modifying grid parameters, modifying wireless access point placement, and deforming radio frequency propagation.

Various modifications may be applied to the network to check and determine the robustness of the wireless network. After each modification the coverage may be re-determined to see whether a small or large impact was obtained for coverage. If a small change in coverage was obtained by modifying the network then the network may be considered rather robust. If a modification to the network results in a large change in coverage, especially if the modification is a small one, then the network may be considered not robust.

The grid parameters may be modified (step 1220) and the placement process may be repeated. In other words, process 800 may be re-run but with modified grid parameters. Possible modified grid parameters include a grid overlap or may include a grid overlap that is different than previously run, a different grid offset resulting in a different placement of the grid lines, or a similar grid difference. The result is that a similar number or identical number of access points will be included in the wireless network.

An access point placement may be modified (step 1222). One or more access points may be randomly moved within close proximity of their original or originally planned location. The impact may emulate the impact of an installation error, such as an access point being placed on the wrong street lamp.

The radio frequency propagation may be deformed (step 1224). A bias may be assumed in the wireless signal propagation. One example might be a 5 dB degradation in signal at reception nodes.

One or more of the steps 1220, 1222, and 1224 may be performed and the resulting coverage may be evaluated (step 1230). If the coverage changed significantly due to one or more of the 1220, 1222, and 1224 steps being performed then the network is not robust and the validation process 1200 would show the concern.

In an alternate embodiment, rather than looking at the amount of coverage change, the number of additional access points may be evaluated in order to reach the original wireless network coverage (step 1240). In some embodiments both the coverage change and the evaluation of the number of additional access points may both be used to determine a quality metric for the network and thereby validate the network. The validating may further comprise quantifying a number of additional wireless access points needed to reach the quality of coverage which was previously calculated during the analyzing.

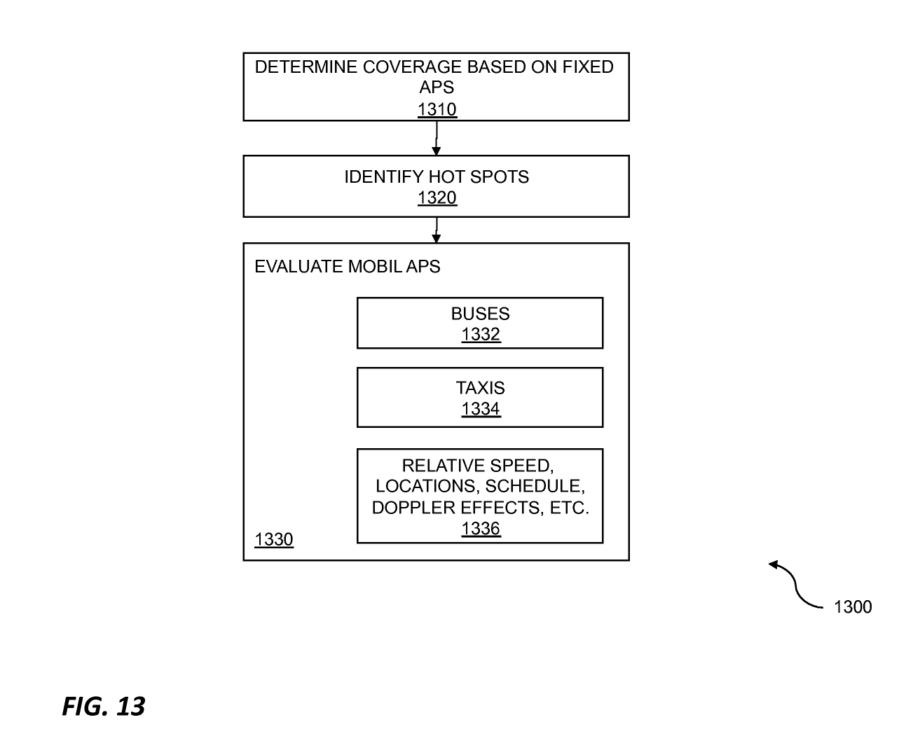

FIG. 13 is a flowchart for using mobile access points to provide network coverage. Process 1300 begins by determining the coverage based on access points in a wireless network. The coverage may be the amount of area within an area of interest which meets a minimum wireless signal level.

Hot spots within the area of interest may be identified (step 1320). These hot spots may be areas where larger amounts of traffic occur or are expected to occur. In some embodiments, areas where coverage is weak may be evaluated.

Mobile access points may be placed on various vehicles (step 1330). The process may include analyzing the model for one of the plurality of segments based on mobile wireless access points within the one of the plurality of segments. In some embodiments buses (step 1332) may be preferably used for placement of mobile access points. Due to relatively slower speed and slower accelerations, there is less concern about Doppler effects. Likewise, there is less handoff between fixed access points, again due to relatively slower speeds of buses. Within a city, buses may circulate to the higher data traffic areas during the key times during the day. Likewise, the buses may not necessarily circulate during data traffic times which are lower. The impact of mobile access point being placed on buses may be evaluated for benefits to the wireless coverage. In some embodiments, mobile access points may only be placed on buses.

Alternatively, mobile access points may be placed on taxis (step 1334). In some embodiments mobile access points may only be placed on taxis. In other embodiments, mobile access points may be placed on both buses and taxis. Again, the wireless network coverage benefit may be calculated based on the placement of mobile access points on taxis. In other embodiments other vehicles, especially vehicles that are government owned or operated, may be used as mobile access points.

Various effects need to be considered in evaluating mobile access points, including but not limited to: relative speed, location of the mobile access points, schedule of operation of the vehicles, Doppler effects on the wireless signals, and the like (step 1336).

Throughout this disclosure and elsewhere, references to industry standards such as those published by the Internet Engineering Task Force and the Institute of Electrical and Electronics Engineers provide non-limiting, illustrative examples for enabling one of ordinary skill in the art to practice what this specification describes. It will be appreciated that a variety of functional equivalents to the disclosed industry standards exist or are possible. All such equivalents are intended to fall within the scope of this specification.

It will be understood that for each flow chart, the depicted steps are provide for purposes of illustration and explanation only, and that the steps may be modified, omitted, or re-ordered, and other steps may be added, without departing from the scope of this disclosure. While the foregoing drawings and description set forth functional aspects of the disclosed systems, no particular arrangement of software and/or hardware for implementing these functional aspects should be inferred from these descriptions unless explicitly stated or otherwise clear from the context, and all such arrangements of software and/or hardware are intended to fall within the scope of this disclosure.

The methods or processes described herein may in general be realized as a computer program product embodied in a computer readable storage medium that performs the corresponding steps, or as a device including a processor, memory and/or other circuits configured through programming or the like to perform the steps described. Traditionally, a computer program consists of a finite sequence of computational instructions or program instructions. It will be appreciated that a programmable apparatus can receive such a computer program and, by processing the computational instructions thereof, produce a further technical effect. Regardless of the type of computer program or computer involved, a computer program can be loaded onto a computer to produce a particular machine that can perform any and all of the depicted functions. This particular machine provides a means for carrying out any and all of the depicted functions.

A processor or programmable apparatus as described herein may include one or more microprocessors, microcontrollers, embedded microcontrollers, programmable digital signal processors, programmable devices, programmable gate arrays, programmable array logic, memory devices, application specific integrated circuits, quantum computing devices, optical computing devices, or any other combination of discrete and/or programmable electronic devices, which can be suitably employed or configured to process computer program instructions, execute computer logic, store computer data, and so on. A computer or processor as described herein may include a general purpose computer, a special-purpose computer, a programmable data processing apparatus, a processor, and so on as well as any combination of the foregoing. Signal processing circuitry may in general include any of the foregoing, as well as any other analog and/or digital circuitry suitable for predetermined or programmable operation.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may more generally include any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, it will be understood that the depicted elements and the functions thereof may be implemented as parts of a monolithic software structure, as standalone software modules, or as modules that employ external routines, code, services, and so forth, or any combination of these. At the same time execution of the depicted processes may be single or multi-threaded and/or configured for execution on one or more processors. All such implementations are within the scope of the present disclosure.

In view of the foregoing, it will be appreciated that elements of the block diagrams and flowchart illustrations support combinations of means for performing the specified functions, combinations of steps for performing the specified functions, computer executable code for performing the specified functions, and so on.

It will be appreciated that computer executable code may include may include any program instructions or the like. A variety of languages for expressing computer program instructions are possible, including without limitation structured programming languages such as C, C++, Java, JavaScript, assembly language, Lisp, and so on. Such languages may also or instead include assembly languages, hardware description languages, database programming languages, functional programming languages, imperative programming languages, structured programming languages, object-oriented programming languages, scripting languages, high-level languages, low-level languages, and so on. In some embodiments, computer program instructions can be stored, compiled, or interpreted to run on a computer, a programmable data processing apparatus, a heterogeneous combination of processors or processor architectures, and so on. Without limitation, embodiments of the present invention can take the form of web-based computer software, which includes client/server software, software-as-a-service, peer-to-peer software, or the like.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

1. A method comprising:
determining an area of interest for deployment of a wireless ad hoc network;
dividing the area of interest into a plurality of segments and forming a model for each of the plurality of segments, the model including one or more aggregate properties for wireless signal propagation through a corresponding one of the plurality of segments;
analyzing the area of interest using the model for each one of the plurality of segments to determine a quality of coverage by the wireless ad hoc network at one or more locations within the area of interest;
placing a wireless access point within a region of the area of interest where the quality of coverage falls beneath a predetermined threshold; and
transmitting data across the wireless ad hoc network using the wireless access point.

2. The method of claim 1 wherein the model comprises information on one or more of street furniture, height plans, clutter limits, foliage, and rooftop diffraction.

3. The method of claim 1 wherein the analyzing comprises planning street level interactions between nodes in the wireless ad hoc network in one of the plurality of segments.

4. The method of claim 1 wherein the analyzing comprises computing spanning network connectivity.

5. The method of claim 1 wherein the analyzing comprises Monte Carlo analysis of the quality of coverage.

6. The method of claim 1 further comprising analyzing the quality of coverage based on the wireless access point which was placed.

7. The method of claim 1 wherein the model comprises information on one or more of demographics, usage, and spectrum availability.

8. The method of claim 1 wherein the placing of the wireless access point is accomplished by forming a grid of multiple grid sections; searching within each of the multiple grid sections for a possible placement of the wireless access point; and placing the wireless access point within one of the multiple grid sections.

9. The method of claim 8 wherein a search box is formed at a center of one of the multiple grid sections and the wireless access point is placed in the search box.

10. The method of claim 9 wherein the multiple grid sections correspond to the plurality of segments.

11. The method of claim 8 further comprising validating the wireless ad hoc network within one of the plurality of segments wherein validating comprises modifying the model for the one of the plurality of segments and analyzing the model which was modified for the quality of coverage.

12. The method of claim 11 wherein the modifying the model comprises one or more of modifying grid parameters, modifying wireless access point placement, and deforming radio frequency propagation.

13. The method of claim 11 wherein the validating further comprises quantifying a number of additional wireless access points needed to reach the quality of coverage which was previously calculated during the analyzing.

14. The method of claim 1 wherein the wireless access point is placed within a search box where the search box is centered at a location of greatest coverage need.

15. The method of claim 1 further comprising analyzing the model for one of the plurality of segments based on mobile wireless access points within the one of the plurality of segments.

16. The method of claim 15 wherein the analyzing further comprises computing spanning network connectivity considering the presence of the mobile wireless access points and one or more of routes for the mobile wireless access points and density of the mobile wireless access points.

17. A computer program product embodied in a computer readable medium that, when executed, analyzes wireless communication by performing the steps of:
determining an area of interest for deployment of a wireless ad hoc network;
dividing the area of interest into a plurality of segments and forming a model for each of the plurality of segments, the model including one or more aggregate properties for wireless signal propagation through a corresponding one of the plurality of segments;
analyzing the area of interest using the model for each one of the plurality of segments to determine a quality of coverage by the wireless ad hoc network at one or more locations within the area of interest; and
evaluating placement for a wireless access point within a region of the area of interest where the quality of coverage falls beneath a predetermined threshold.

18-23. (canceled)

24. The computer program product of claim 17 wherein the evaluating placement of the wireless access point is accomplished by forming a grid of multiple grid sections; searching within each of the multiple grid sections for a possible placement of the wireless access point; and placing the wireless access point within one of the multiple grid sections.

25-32. (canceled)

33. A system for analyzing wireless communication comprising:
a processor configured to:
determine an area of interest for deployment of a wireless ad hoc network;
divide the area of interest into a plurality of segments and form a model for each of the plurality of segments, the model including one or more aggregate properties for wireless signal propagation through a corresponding one of the plurality of segments;
analyze the area of interest using the model for each one of the plurality of segments to determine a quality of coverage by the wireless ad hoc network at one or more locations within the area of interest; and
evaluate placement for a wireless access point within a region of the area of interest where the quality of coverage falls beneath a predetermined threshold; and
a display to present the placement for the wireless access point within the region of the area of interest.

34-39. (canceled)

40. The system of claim 33 wherein evaluation of placement of the wireless access point is accomplished by forming a grid of multiple grid sections; searching within each of the multiple grid sections for a possible placement of the wireless access point; and placing the wireless access point within one of the multiple grid sections.

41-48. (canceled)
